(19) United States
(12) Patent Application Publication
(10) Pub. No.: US 2012/0245907 A1
(43) Pub. Date: Sep. 27, 2012

(54) POWER CONSUMPTION VERIFICATION SUPPORT APPARATUS AND POWER CONSUMPTION VERIFICATION SUPPORT METHOD

(75) Inventor: Akihisa YAGYUU, Kanagawa (JP)

(73) Assignee: KABUSHIKI KAISHA TOSHIBA, Tokyo (JP)

(21) Appl. No.: 13/236,463

(22) Filed: Sep. 19, 2011

(30) Foreign Application Priority Data
Mar. 24, 2011 (JP) 2011-066465

(51) Int. Cl. G06F 17/50

(52) U.S. Cl. 703/2

(57) ABSTRACT

A power consumption verification support apparatus of an embodiment has a power consumption approximate calculation module, a comparison/determination module, a delay control module, and a dump processing module. The power consumption approximate calculation module approximately calculates power consumption at each predetermined time of a first simulation that observes a designation signal. The comparison/determination module compares an approximately calculated value of the power consumption with a threshold value, and determines whether or not to perform dump processing for each predetermined time from a comparison result. The delay control module causes a second simulation that observes all signals to be executed by delaying the second simulation by the predetermined time with respect to the first simulation. The dump processing module stores waveform data of all the signals for the predetermined time for which the dump processing is determined to be performed.

### CROSS REFERENCE TO RELATED APPLICATION

This application is based upon and claims the benefit of priority from the prior Japanese Patent Application No. 2011-66465 filed on Mar. 24, 2011; the entire contents of which are incorporated herein by reference.

### FIELD

Embodiments described herein relate generally to a power consumption verification support apparatus and a power consumption verification support method.

### BACKGROUND

In recent years, with increase in the circuit scales of semiconductor integrated circuits, power consumption has tended to increase, and importance of power consumption verification has been increasing. When power consumption verification is performed, it is necessary to perform logic simulation by using a logic simulator and to create a waveform information file such as an FSDB file or a VCD file, in which waveform data is stored. Thereafter, the waveform information file created by the logic simulation is read by a commercially available power consumption verification tool, and verification of the detailed power consumption is performed.

However, due to an increase in the scale of a semiconductor integrated circuit of recent years, in the case of creation of a waveform information file with use of a logic simulator, there arises a problem that the logic simulation lasts for a long period like several tens of hours or several days, for example. Further, due to an increase in the scale of semiconductor integrated circuits, the waveform information files themselves increase in scale, due to which, there arises a problem that the time period of verification of power consumption with a power consumption verification tool becomes long, and the like.

Further, when a waveform information file is created with use of a logic simulator, thinning verification can be performed for the purpose of reducing the time of the logic simulation. In the thinning verification, waveform data is acquired at certain fixed time intervals. Therefore, with thinning verification, the waveform data that is actually necessary, for example, the waveform data at a peak power consumption time may not be obtained. As a result, in order to obtain necessary waveform data, logic simulation needs to be repeated several times, and there arises a problem that it takes much time to perform a logic simulation.

### BRIEF DESCRIPTION OF THE DRAWINGS

FIG. 1 is a view showing a configuration of an information processing system according to a first embodiment;

FIG. 2 is a diagram showing a configuration of a power consumption verification support apparatus according to the first embodiment;

FIG. 3 is an explanatory diagram for explaining an operation of the power consumption verification support apparatus according to the first embodiment;

FIG. 4 is a flowchart showing an example of a flow of a simulation for approximate calculation of power consumption;

FIG. 5 is a flowchart showing an example of a flow of a simulation for signal dump processing;

FIG. 6 is a diagram showing a configuration of a power consumption verification support apparatus according to a second embodiment;

FIG. 7 is an explanatory diagram for explaining an operation of the power consumption verification support apparatus according to the second embodiment;

FIG. 8 is a flowchart showing an example of a flow of a simulation that is executed in a simulator 22;

FIG. 9 is a diagram showing a configuration of a power consumption verification support apparatus according to a third embodiment;

FIG. 10 is an explanatory diagram for explaining an operation of the power consumption verification support apparatus according to the third embodiment;

FIG. 11 is a diagram showing a configuration of a power consumption verification support apparatus according to a fourth embodiment;

FIG. 12 is a diagram for explaining an operation of the power consumption verification support apparatus according to the fourth embodiment;

FIG. 13 is a flowchart showing an example of a flow of a simulation that is executed in a simulator 12b;

FIG. 14 is a diagram showing a configuration of a power consumption verification support apparatus according to a fifth embodiment;

FIG. 15 is a diagram for explaining an operation of the power consumption verification support apparatus according to the fifth embodiment;

FIG. 16 is a flowchart showing an example of a flow of a simulation for approximate calculation of power consumption that is executed in a simulator 12c;

FIG. 17 is a diagram showing a configuration of a power consumption verification support apparatus according to a sixth embodiment;

FIG. 18 is a diagram for explaining an operation of the power consumption verification support apparatus according to the sixth embodiment; and

FIG. 19 is a flowchart showing an example of a flow of the simulation for approximate calculation of power consumption executed in the simulator 12d.

### DETAILED DESCRIPTION

A power consumption verification support apparatus of an embodiment has a power consumption approximate calculation module, a comparison/determination module, a delay control module, and a dump processing module. The power consumption approximate calculation module approximately calculates power consumption for each of predetermined time of a first simulation that observes a designated signal. The comparison/determination module compares an approximately calculated value of power consumption approximately calculated in the power consumption approximate calculation module with a threshold value, and determines whether or not to perform dump processing for each of the predetermined time from the comparison result. The delay control module causes a second simulation that observes all signals to be executed by delaying the second simulation by a predetermined time with respect to the first simulation. The dump processing module stores waveform data of all the signals during a predetermined time for which dump processing is determined to be performed based on the determination result of the comparison/determination module.

Hereinafter, embodiments of the present invention will be described in detail with reference to the drawings.

### First Embodiment

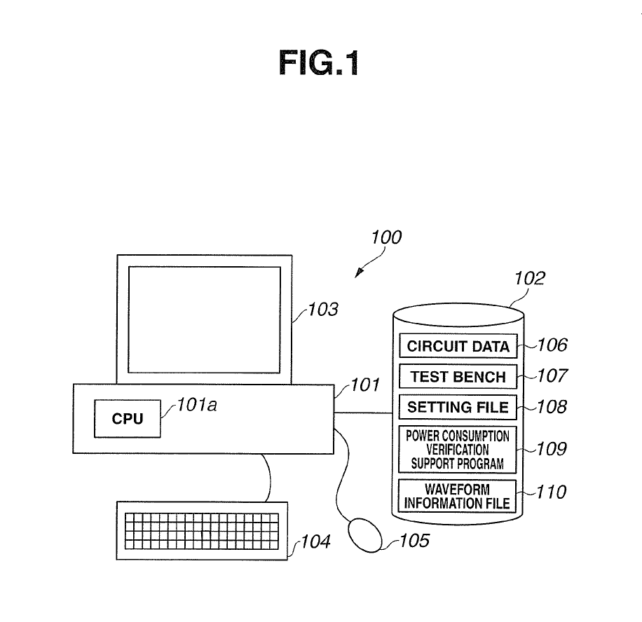

First, based on FIG. 1, a configuration of an information processing system according to a first embodiment will be described.

FIG. 1 is a view showing the configuration of the information processing system according to the first embodiment.

As shown in FIG. 1, an information processing system 100 is configured by having a main apparatus 101, a storage apparatus 102 configured to store various data, and a display apparatus 103 configured to display various data. The main apparatus 101 is a computer apparatus main body such as a personal computer, and is loaded with a CPU 101a, a main memory not illustrated, and the like. Further, a keyboard 104 and a mouse 105 are connected to the main apparatus 101, as input devices. The main apparatus 101 executes various programs based on an instruction from the input devices.

Circuit data 106 described in a hardware description language (HDL) or the like, a test bench 107 in which a test pattern for performing a logic simulation of the circuit data 106 is described, a setting file 108 in which setting information at the time of execution of a logic simulation is described, a power consumption verification support program 109 configured to read the circuit data 106, the test bench 107 and the setting file 108 and execute a logic simulation, and a waveform information file 110 that is obtained by execution of the power consumption verification support program 109 are stored in the storage apparatus 102. The setting information of the setting file 108 is, as described later, information of threshold values, information of delay times, information of signals (designation signal) to be dumped and the like.

A user uses the keyboard 104 and the mouse 105, has the circuit data 106, the test bench 107 and the setting file 108 as input, executes the power consumption verification support program 109 in the main apparatus 101, and thereby, can obtain the waveform information file 110. Like this, the main apparatus 101 that can execute the power consumption verification support program 109 configures the power consumption verification support apparatus 1 of the present embodiment which will be described later. The circuit data 106, the test bench 107, the setting file 108 and the waveform information file 110 are stored in the storage apparatus 102, but may be stored in another storage medium.

Here, a configuration of the power consumption verification support apparatus 1 which is configured as above will be described.

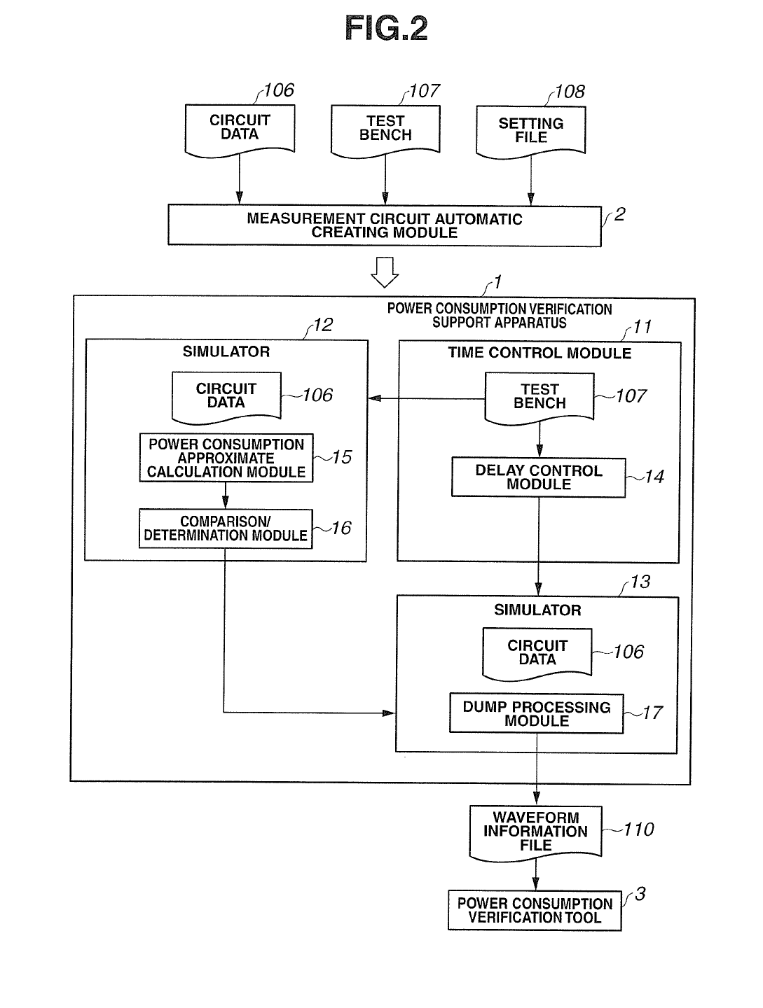

FIG. 2 is a diagram showing the configuration of the power consumption verification support apparatus according to the first embodiment.

First, a user has the circuit data 106, the test bench 107 and the setting file 108 as input, and executes the power consumption verification support program 109 in the main apparatus 101, whereby compile is executed in a measurement circuit creating module 2. A compiler which configures the measurement circuit creating module 2 is stored in the storage apparatus 102, though not illustrated.

The measurement circuit creating module 2 converts the circuit data 106, the test bench 107 and the setting file 108 into binary data the processing of which can be executed by a computer from ASCII data which the user can read. The measurement circuit creating module 2 outputs the circuit data 106, the test bench 107 and the setting file 108 which have been converted into binary data to the power consumption verification support apparatus 1.

The power consumption verification support apparatus 1 is configured by having a time control module 11, a simulator 12 configured to execute a simulation for approximate calculation of power consumption, and a simulator 13 configured to execute a simulation for signal dump processing. The simulation for approximate calculation of power consumption is a simulation for calculating rough power consumption with only the availability of the designation signal set in the setting file 108 or the designation signal being dumped. Further, the simulation for signal dump processing is a simulation for creating the waveform information file 110 with all signals being dumped when an instruction for dump processing is given.

The test bench 107 is inputted to the time control module 11. The time control module 11 divides a simulation time of the test bench 107 into predetermined time ΔT units, and performs control of causing the simulation corresponding to the test bench 107 to be executed in the simulator 12 and the simulator 13. The predetermined time ΔT is set according to the setting file 108.

The time control module 11 has a delay control module 14. The delay control module 14 performs control of causing the simulation for signal dump processing to be executed in the simulator 13 by delaying the simulation for signal dump processing by the predetermined time ΔT with respect to the simulation for approximate calculation of power consumption executed in the simulator 12. Further, the delay control module 14 performs control of causing the simulation for a signal dump processing to be executed in the simulator 13 while keeping a delay of the predetermined time ΔT with respect to the simulation for approximate calculation of power consumption that is executed in the simulator 12.

The simulator 12 executes the simulation for approximate calculation of power consumption in accordance with control from the time control module 11. Further, the simulator 12 has a power consumption approximate calculation module 15 and a comparison/determination module 16.

The power consumption approximate calculation module 15 approximately calculates power consumption per the predetermined time ΔT divided in the time control module 11, and outputs the approximately calculated value of the power consumption to the comparison/determination module 16.

The comparison/determination module 16 compares the approximately calculated value of the power consumption that is inputted from the power consumption approximate calculation module 15 and a threshold value TH, and determines whether or not the approximately calculated value of the power consumption is the threshold value TH or larger. The threshold value TH is set in the setting file 108. When the comparison/determination module 16 determines that the approximately calculated value of power consumption is the threshold value TH or larger, the comparison/determination module 16 instructs the simulator 13 to perform execution of a simulation with dump processing, and when the comparison/determination module 16 determines that the approximately calculated value of the power consumption is less than the threshold value TH, the comparison/determination module 16 instructs the simulator 13 to perform execution of a simulation without dump processing.

The simulator 13 executes the simulation for signal dump processing by delaying the simulation for signal dump processing by the predetermined time ΔT with respect to the simulation for approximate calculation of power consumption, in response to control from the delay control module 14 of the time control module 11. Further, the simulator 13 has a dump processing module 17.

When the dump processing module 17 is given an instruction to perform dump processing from the comparison/determination module 16, the dump processing module 17 performs dump processing of storing waveform data of all signals during the predetermined time ΔT in a waveform information file 110, whereas when the dump processing module 17 is not given an instruction of dump processing, the dump processing module 17 does not perform dump processing. Consequently, the dump processing module 17 outputs the waveform information file 110 in which the waveform data during the period for which an instruction to perform dump processing is given is stored.

The waveform information file 110 is read by a power consumption verification tool 3. The power consumption verification tool 3 executes verification of detailed power consumption based on the waveform data stored in the waveform information file 110.

Next, an operation of the power consumption verification support apparatus 1 configured as above will be described.

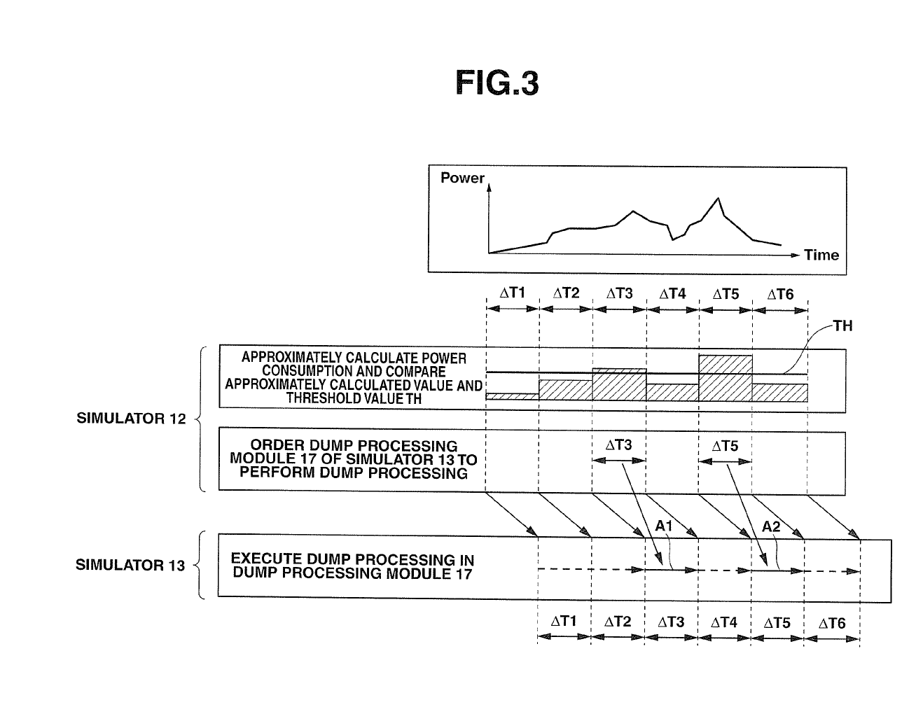

FIG. 3 is an explanatory diagram for explaining the operation of the power consumption verification support apparatus according to the first embodiment.

First, the simulation time is divided into the predetermined time ΔT units. In the example of FIG. 3, predetermined times ΔT are expressed as ΔT1, ΔT2, . . . , ΔT6 from the start of the simulation. Next, the power consumption in the predetermined time ΔT1 is approximately calculated by the power consumption approximate calculation module 15 of the simulator 12. The comparison/determination module 16 of the simulator 12 compares the approximately calculated value of the power consumption that is approximately calculated in the power consumption approximate calculation module 15 and the threshold value TH, and determines whether or not the approximately calculated value is the threshold value TH or larger. Since in the predetermined time ΔT1, the approximately calculated value (rectangular diagonally shaded area) of the power consumption is lower than the threshold value TH, an instruction for dump processing to the dump processing module 17 is not executed from the comparison/determination module 16. Subsequently, the flow shifts to a next predetermined time ΔT2, and similar processing is performed.

When the comparison/determination module 16 determines that the approximately calculated value of the power consumption in the predetermined time ΔT3 is the threshold value TH or larger, the comparison/determination module 16 orders the dump processing module 17 of the simulator 13 to perform dump processing. The simulator 13 executes a simulation while keeping delay of the predetermined time ΔT with respect to the simulator 12 by control of the delay control module 14. Therefore, when the order of dump processing for the predetermined time ΔT3 is given from the comparison/determination module 16, the dump processing module 17 executes dump processing for the predetermined time ΔT3 shown by an arrow A1.

Similar processing is repeated for the predetermined time ΔT4 and the following times, and thereby, the dump processing module 17 outputs the waveform information file 110 storing the detailed waveform data of the time zones where the approximately calculated value of power consumption is the threshold value TH or larger; in the example of FIG. 3, only the time zones shown by the arrows A1 and A2.

Next, the flows of the simulation for approximate calculation of power consumption and the simulation for signal dump processing will be described.

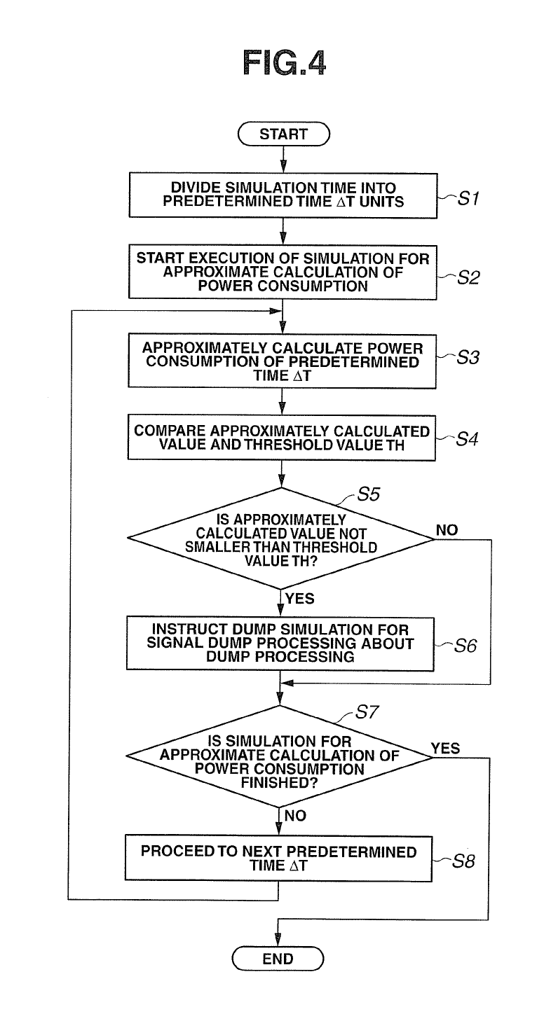

FIG. 4 is a flowchart showing an example of the flow of the simulation for approximate calculation of power consumption.

First, the simulation time is divided into the predetermined time ΔT units (step S1), and execution of the simulation for approximate calculation of power consumption is started (step S2). Next, the power consumption of the predetermined time ΔT is approximately calculated (step S3), and the approximately calculated value that is approximately calculated and the threshold value TH are compared (step S4).

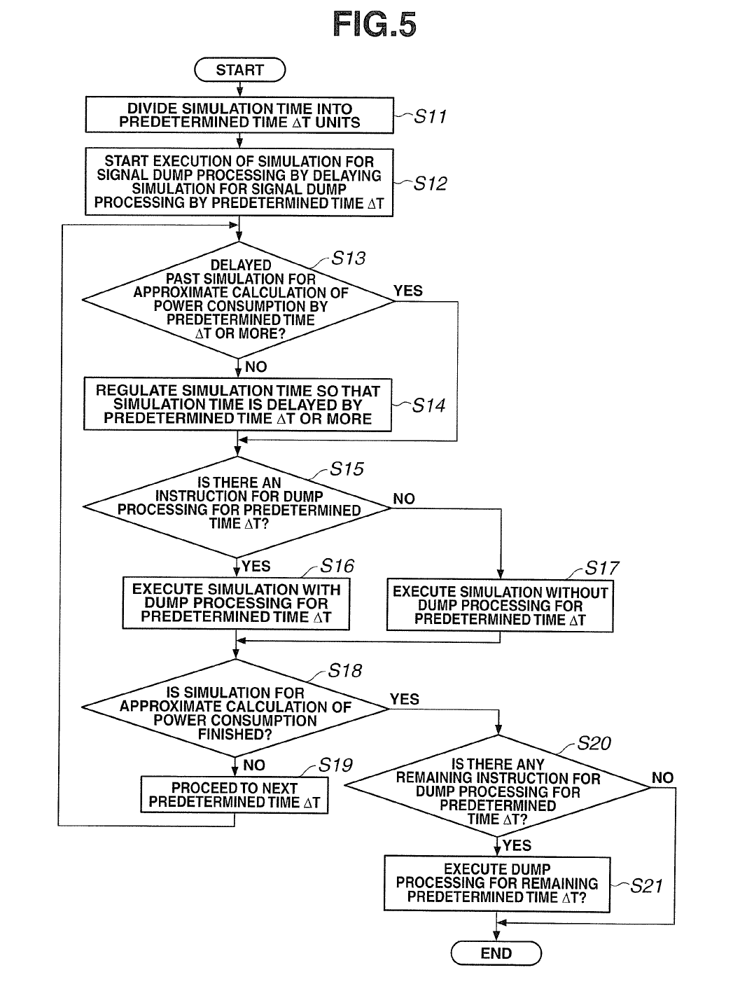

Next, it is determined whether or not the approximately calculated value is the threshold value TH or larger (step S5). If the approximately calculated value is determined to be the threshold value TH or larger, the determination result is YES, an instruction to perform dump processing is given to the simulation for signal dump processing (step S6), and the flow proceeds to step S7. The flow of the simulation for signal dump processing will be described with use of FIG. 5. On the other hand, if the approximately calculated value is determined to be less than the threshold value TH, the determination result is No, and it is determined whether or not the simulation for approximate calculation of power consumption is finished (step S7). If it is determined that the simulation for approximate calculation of power consumption is not finished, the determination result is NO. The flow proceeds to a next predetermined time ΔT (step S8), the flow returns to step S3, and similar processing is repeated. On the other hand, if it is determined that the simulation for approximate calculation of power consumption is finished, the determination result is YES, and the simulation for approximate calculation of power consumption is finished.

Next, with use of FIG. 5, processing of the simulation for signal dump processing of step S6 will be described.

FIG. 5 is a flowchart showing an example of the flow of the simulation for signal dump processing.

First, simulation time is divided into the predetermined time ΔT units (step S11), and execution of the simulation for signal dump processing is started by being delayed by the predetermined time ΔT (step S12). Next, it is determined whether or not the simulation for signal dump processing is delayed by the predetermined time ΔT or more past the simulation for approximate calculation of power consumption (step S13). If it is determined that the simulation for signal dump processing is delayed by the predetermined time ΔT or more, the determination result is YES, and the flow proceeds to step S15. On the other hand, if it is determined that the simulation for signal dump processing is not delayed by the predetermined time ΔT or more, the determination result is NO, the simulation time is regulated so that the simulation for signal dump processing is delayed by the predetermined time ΔT or more (step S14), and the flow proceeds to step S15. Next, it is determined whether or not there is an instruction to perform dump processing for the predetermined time ΔT (step S15). If it is determined that there is an instruction to perform dump processing, the determination result is YES, the simulation with dump processing is executed for the predetermined time ΔT (step S16), and the flow proceeds to step S18. On the other hand, if it is determined that there is no instruction to perform dump processing, the determination result is NO, the simulation without dump processing is executed for the predetermined time Δ (step S17), and the flow proceeds to step S18. Next, it is determined whether or not the simulation for approximate calculation of power consumption is finished (step S18). If it is determined that the simulation for approximate calculation of power consumption is not finished, the determination result is NO, the flow proceeds to the next predetermined time ΔT (step S19), the flow returns to step S13, and similar processing is repeated. On the other hand, if it is determined that the simulation for approximate calculation of power consumption is finished, the determination result is YES, and it is determined whether or not there is any remaining instruction to perform dump processing for the predetermined time ΔT (step S20). If it is determined that there is a remaining instruction, the determination result is YES, dump processing for the remaining predetermined time ΔT is executed (step S21), and the processing is finished. On the other hand, if it is determined that there is no remaining instruction, the determination result is NO, and the simulation for signal dump processing is finished.

As above, the power consumption verification support apparatus 1 causes the processing of determining creation of the waveform information file 110 necessary for the power consumption verification tool 3, and the processing of creating the waveform information file 110 to be shared by a plurality of simulators, namely, the simulators 12 and 13 in the present embodiment. As a result, the load exerted on the single simulator can be reduced.

Furthermore, the power consumption verification support apparatus 1 determines whether or not the approximately calculated value of the power consumption is the threshold value TH or larger, and stores only the waveform data of the time zone in which the approximately calculated value of the power consumption is the threshold value TH or larger, in the waveform information file 110. As a result, the power consumption verification support apparatus 1 can acquire necessary waveform data, and the simulation time for creating the waveform information file 110 can be reduced. Further, the power consumption verification support apparatus 1 stores only the waveform data of the time zone in which the approximately calculated value of the power consumption is the threshold value TH or larger, in the waveform information file 110, and therefore, the file size and the number of files of the waveform information file 110 can be reduced. As a result, the verification time of power consumption with the power consumption verification tool 3 can be reduced.

### Second Embodiment

Next, a second embodiment will be described.

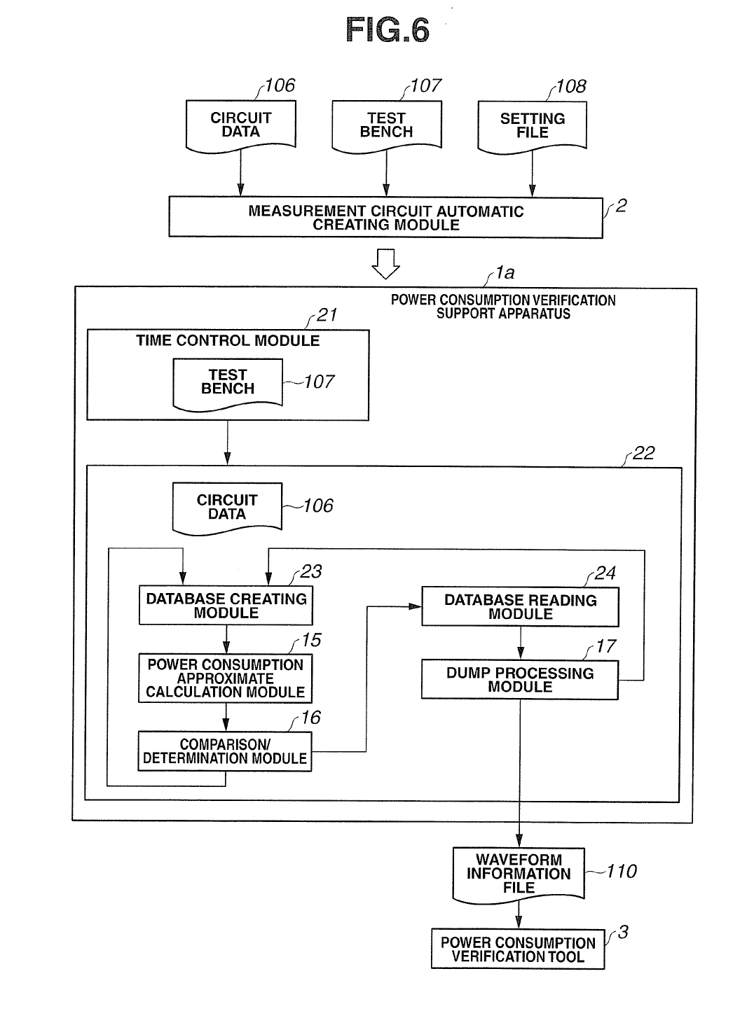

FIG. 6 is a diagram showing a configuration of a power consumption verification support apparatus according to the second embodiment. In FIG. 6, the same components as those in FIG. 2 are assigned with the same reference numerals, and the description thereof will be omitted.

A power consumption verification support apparatus 1a is configured by having a time control module 21 and a simulator 22.

The time control module 21 divides a simulation time of a test bench 107 into predetermined time ΔT units, and performs control of causing the simulator 22 to execute a simulation corresponding to the test bench 107, similarly to the time control module 11 of FIG. 2.

The simulator 22 is configured by having a database creating module 23 and a database reading module 24 in addition to the power consumption approximate calculation module 15, the comparison/determination module 16 and the dump processing module 17 of FIG. 2.

The database creating module 23 creates a database for executing a simulation again from a start time of the predetermined time ΔT after execution of the simulation of the predetermined time ΔT.

The database reading module 24 reads the database created in the database creating module 23 when the approximately calculated value of the power consumption approximately calculated in the power consumption approximate calculation module 15 is determined to be the threshold value TH or larger by the comparison/determination module 16. When the approximately calculated value that is calculated in the power consumption approximate calculation module 15 is determined to be less than the threshold value TH by the comparison/determination module 16, the flow proceeds to the next predetermined time ΔT, and similar processing is repeated.

The dump processing module 17 creates the waveform information file 110 by executing dump processing again from the starting time of the predetermined time ΔT based on the database that is read by the database reading module 24, and proceeds to the next predetermined time ΔT. The simulator 22 repeats the above processing until the simulation is finished, and thereby, creates the waveform information file 110 storing only the waveform data of the time zone in which the approximately calculated value of the power consumption is the threshold value TH or larger.

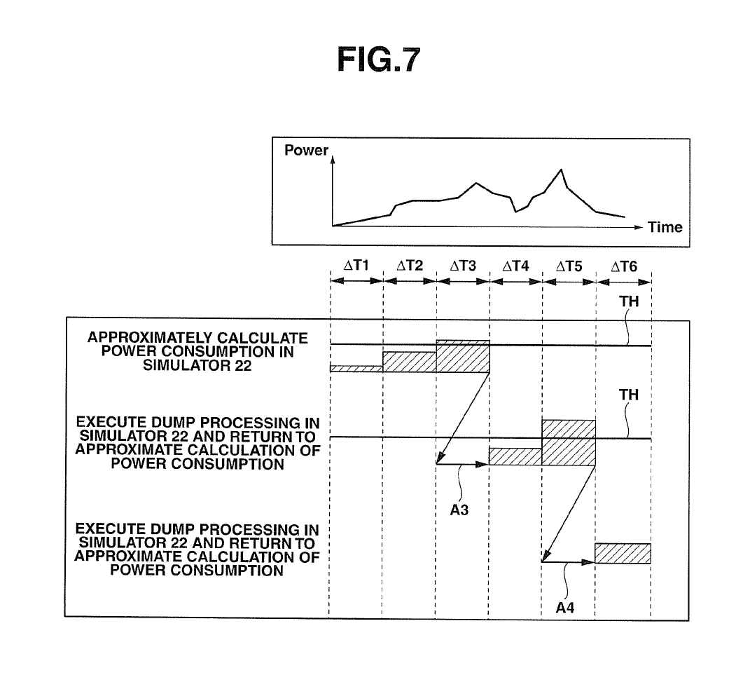

FIG. 7 is an explanatory diagram for describing an operation of the power consumption verification support apparatus according to the second embodiment.

When it is determined that approximately calculated value is the threshold value TH or larger in the predetermined time ΔT3, the database for executing the simulation from the starting time of the predetermined time ΔT, which is created in the database creating module 23, is read by the database reading module 24. Thereby, the process returns to the starting time of the predetermined time ΔT3, and the dump processing module 17 executes dump processing for the predetermined time ΔT3 shown by the arrow A3.

Thereafter, at the predetermined time ΔT4, the process returns to the processing of approximately calculating the power consumption, and similar processing is repeated, whereby, the dump processing module 17 outputs the waveform information file 110 storing the detailed waveform data for the time zones where the approximately calculated value of power consumption is the threshold value TH or larger; in the example of FIG. 7, only the time zones shown by the arrows A3 and A4.

Next, a flow of the simulation executed in the simulator 22 will be described.

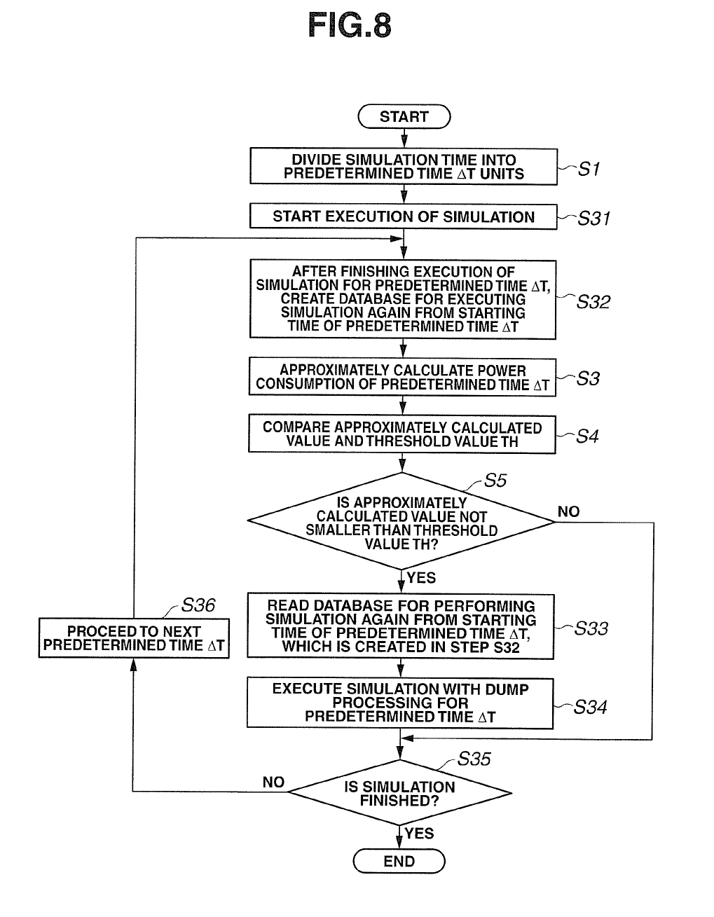

FIG. 8 is a flowchart showing an example of the flow of the simulation executed in the simulator 22. In FIG. 8, the same processes as those of FIG. 4 are assigned with the same reference numerals and characters, and the description thereof will be omitted.

In step S1, when the simulation time is divided into the predetermined time ΔT units, execution of the simulation is started (step S31). Next, after execution of the simulation for the predetermined time ΔT is finished, the database for executing the simulation again from the starting time of the predetermined time ΔT is created (step S32). In step S3, the power consumption of the predetermined time ΔT is approximately calculated, and in step S4, the approximately calculated value and the threshold value TH are compared. Subsequently, in step S5, it is determined whether or not the approximately calculated value is the threshold value TH or larger, and if it is determined that the approximately calculated value is less than the threshold value TH, the flow proceeds to step S35. On the other hand, if the approximately calculated value is determined to be the threshold value TH or larger in step S5, the database for executing the simulation again from the starting time of the predetermined time ΔT, which is created in step S32, is read (step S33). Next, during the predetermined time ΔT, the simulation with dump processing is executed (step S34), and the flow proceeds to step S35. Next, it is determined whether or not the simulation is finished (step S35). If it is determined that the simulation is not finished, the determination result is NO, the flow proceeds to the next predetermined time ΔT (step S36), the flow returns to step S32, and similar processing is repeated. On the other hand, if it is determined that the simulation is finished, the determination result is YES, and the simulation is finished.

As above, the power consumption verification support apparatus 1a creates the database for executing the simulation again from the starting time of the predetermined time ΔT, in the database creating module 23. If the approximately calculated value of the power consumption is the threshold value TH or larger, the power consumption verification support apparatus 1a reads the database, and performs dump processing. Thus, the power consumption verification support apparatus 1a causes different processes to be executed in one simulator 22, and thereby, can reduce the resource for executing the simulation as compared with the power consumption verification support apparatus 1 of the first embodiment including the two simulators 12 and 13.

### Third Embodiment

Next, a third embodiment will be described.

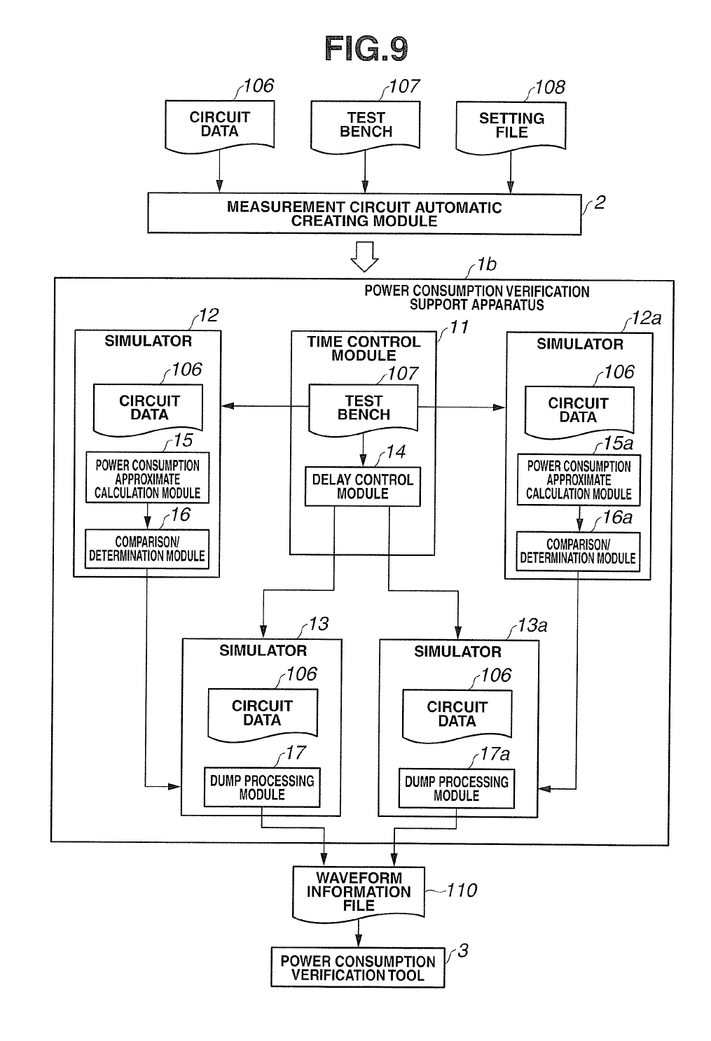

FIG. 9 is a diagram showing a configuration of a power consumption verification support apparatus according to the third embodiment. In FIG. 9, the same components as those in FIG. 2 are assigned with the same reference numerals, and the description thereof will be omitted.

A configuration of a power consumption verification support apparatus 1b of the present embodiment is similar to the configuration of the power consumption verification support apparatus 1 of the first embodiment. The power consumption verification support apparatus 1b of the present embodiment is configured by using simulators 12a and 13a in addition to the simulators 12 and 13 of FIG. 2. The simulators 12a and 13a have the same configurations as those of the simulators 12 and 13, respectively. The simulator 12a has a power consumption approximate calculation module 15a and a comparison/determination module 16a, and the simulator 13a has a dump processing module 17a.

The simulator 12a executes a simulation which is shifted by a predetermined time ΔT/2 from the same simulation as that of the first embodiment which is executed in the simulator 12.

The dump processing module 17a of the simulator 13a executes dump processing with respect to the predetermined time ΔT in which the approximately calculated value of the power consumption in the predetermined time ΔT of the simulation executed in the simulator 12a is the threshold value TH or larger. The other components are the same as those of the first embodiment, and therefore, the description thereof will be omitted.

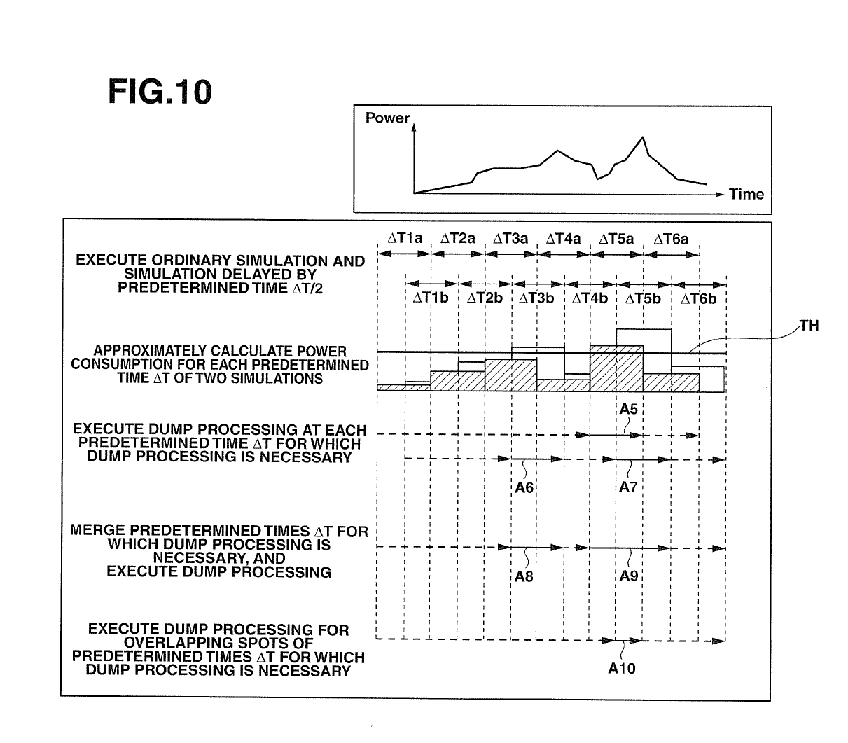

FIG. 10 is an explanatory view for explaining an operation of the power consumption verification support apparatus according to the third embodiment.

In FIG. 10, the predetermined times ΔT of the same simulation as in the first embodiment, which is executed in the simulator 12, are expressed as ΔT1a, ΔT2a, . . . , and ΔT6a from the start of the simulation, whereas the predetermined times ΔT of the simulation shifted by the predetermined time ΔT/2, which is executed in the simulator 12a, are expressed as ΔT1b, ΔT2b, . . . , and ΔT6b from the start of the simulation.

In the power consumption approximate calculation module 15a, the power consumption of each of the predetermined times ΔT 1b to ΔT6b of the simulation executed in the simulator 12a is approximately calculated.

The comparison/determination module 16a determines whether or not the approximately calculated value of the power consumption which is approximately calculated at each of the predetermined times ΔT 1b to ΔT6b of the simulation that is executed in the simulator 12a is the threshold value TH or larger, and instructs the dump processing module 17a to perform dump processing for the predetermined times ΔT3b and ΔT5b in which the approximately calculated values are the threshold value TH or larger, that is, the intervals of arrows A6 and A7. Further, in the simulator 12, the dump processing module 17 is instructed to perform dump processing for the interval of an arrow A5 as in the first embodiment.

The dump processing module 17 or the dump processing module 17a merges the predetermined times ΔT3b, ΔT5a and ΔT5b for which dump processing is required, and executes dump processing for the intervals of arrows A8 and A9. Alternatively, dump processing may be executed for the overlapping spots of the predetermined times ΔT3b, ΔT5a, and ΔT5b for which dump processing is required, in this case, for the interval of an arrow A10 in which the predetermined times ΔT5a and ΔT5b overlap each other.

As above, the power consumption verification support apparatus 1b executes the same simulation as in the first embodiment by the simulator 12, executes the simulation shifted by the predetermined time ΔT/2 in the simulator 12a, and performs dump processing in each of them, and therefore, can increase the precision of dump processing as compared with the power consumption verification support apparatus 1 of the first embodiment.

### Fourth Embodiment

Next, a fourth embodiment will be described.

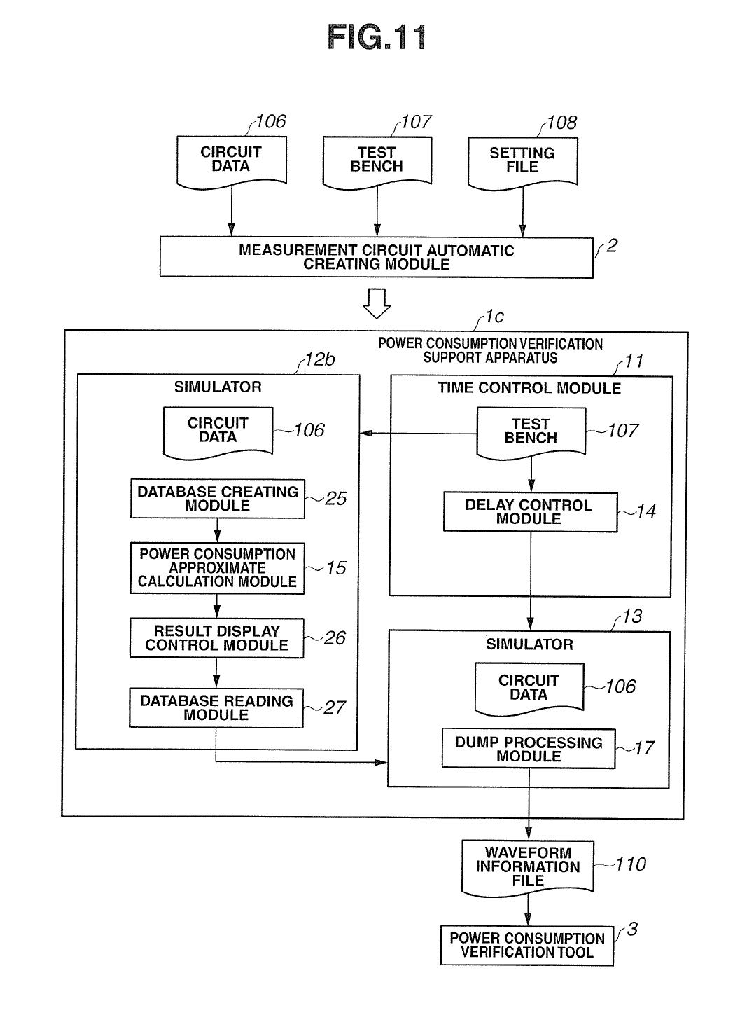

FIG. 11 is a diagram showing a configuration of a power consumption verification support apparatus according to the fourth embodiment. In FIG. 11, the same components as those in FIG. 2 are assigned with the same reference numerals, and the description thereof will be omitted.

A power consumption verification support apparatus 1c is configured by using a simulator 12b instead of the simulator 12 of FIG. 2. The simulator 12b is configured by having a database creating module 25, a result display control module 26 and a database reading module 27 in addition to the power consumption approximate calculation module 15 of FIG. 2.

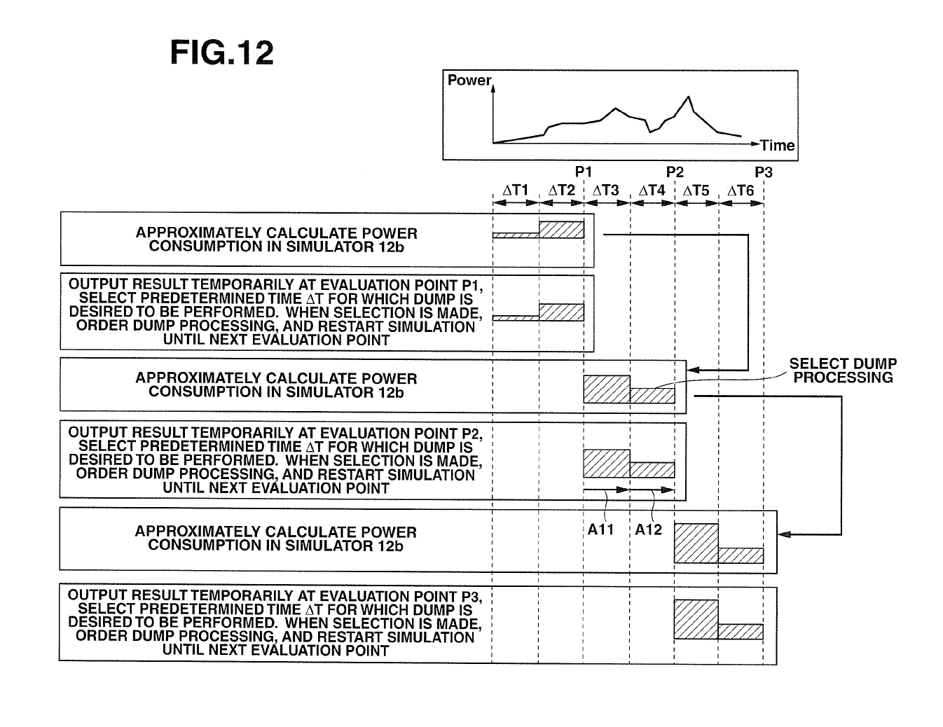

The database creating module 25 creates a database for enabling simulation to be performed again from a starting time of an evaluation point by returning to the starting time of the evaluation point, after the simulation is executed to the evaluation point and finished. Here, the evaluation point is, for example, a point at a time of an integral multiple of the predetermined time ΔT, and in an example in FIG. 12 which will be described later, the evaluation point is the point at a time twice as long as the predetermined time ΔT.

The result display control module 26 performs control of displaying the result of approximate calculation of power consumption on a display module of the display apparatus 103 temporarily at the evaluation point. The display module of the display apparatus 103 allows the user to select the predetermined time ΔT for which the user desires to perform dump processing, from the result of the approximate calculation of power consumption that is displayed.

The database reading module 27 reads the database created in the database creating module 25, and causes the dump processing module 17 to execute dump processing when the user selects the predetermined time ΔT by using the keyboard 104 or the mouse 105 as the input module. The other components are the same as those in the power consumption verification support apparatus 1 of the first embodiment, and therefore, the description thereof will be omitted.

FIG. 12 is a diagram for explaining an operation of the power consumption verification support apparatus according to the fourth embodiment.

First, power consumption in each of the predetermined times ΔT1 and ΔT2 is approximately calculated up to an evaluation point P1 by the simulator 12b. Next, the result of the approximate calculation of the power consumption is displayed on the display module of the display apparatus 103 temporarily at the evaluation point P1. When the user selects the predetermined time ΔT1 or ΔT2 for which the user desires to perform dump, the dump processing module 17 is instructed to perform dump processing. If the user does not select the predetermined time ΔT1 or ΔT2 for which the user desires to perform dump, the simulation is restarted until the next evaluation point P2. The user may select both the predetermined times ΔT1 and ΔT2.

Here, if the user selects a predetermined time ΔT4 as the predetermined time ΔT for which the user desires to perform dump, the database reading module 27 reads the database for enabling the simulation to be performed again from the starting time of the evaluation point P1 from the database creating module 25. Subsequently, dump processing is executed by the dump processing module 17 from the starting time of an evaluation point P1. The dump processing module 17 may perform dump processing only for the predetermined time ΔT4 shown by an arrow A12 selected by the user, without performing dump processing during a predetermined time ΔT3 shown by an arrow A11 which is not selected by the user.

Next, a flow of the simulation executed in the simulator 12b will be described.

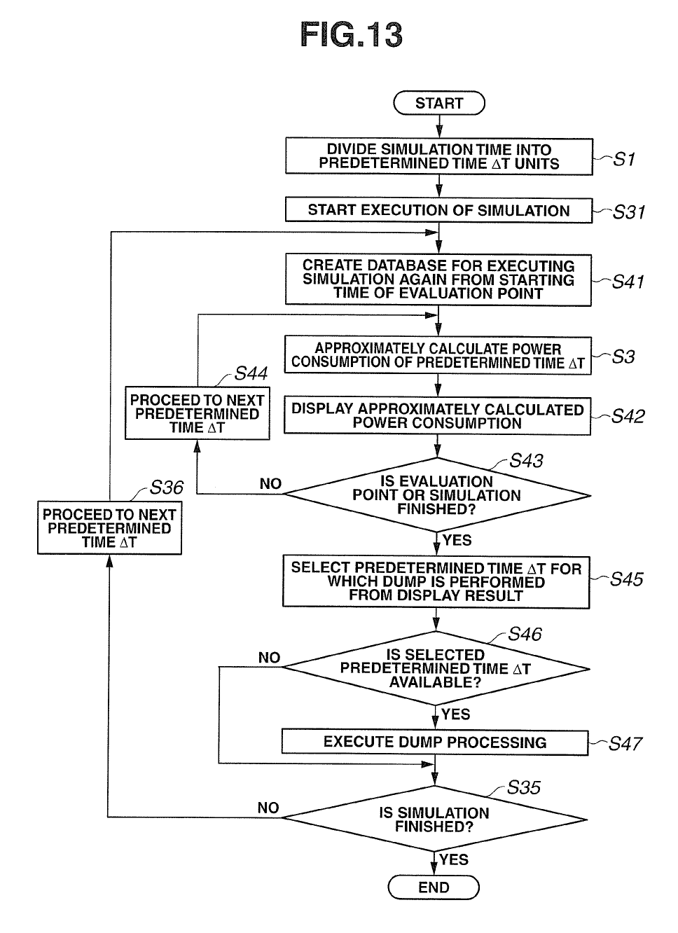

FIG. 13 is a flowchart showing an example of the flow of the simulation executed in the simulator 12b. In FIG. 13, the same processes as those in FIG. 8 are assigned with the same reference numerals and characters, and the description thereof will be omitted.

First, in step S31, when execution of the simulation is started, the database for executing the simulation again from the starting time of the evaluation point is created (step S41). Next, when the power consumption in the predetermined time ΔT is approximately calculated in step S3, the approximately calculated power consumption is displayed (step S42), and it is determined whether or not the evaluation point or the simulation is finished (step S43). If it is determined that the evaluation point or the simulation is not finished, the flow proceeds to the next predetermined time ΔT (step S44), the flow returns to step S3, and the same processes are repeated. On the other hand, if the evaluation point or the simulation is determined to be finished, the predetermined time ΔT for which dump is performed is selected from the display result (step S45).

Next, it is determined whether or not the selected predetermined time ΔT is available (step S46). If it is determined that the selected predetermined time ΔT is available, the determination result is YES, dump processing is executed (step S47), and the flow proceeds to step S35. On the other hand, if it is determined that the selected predetermined time ΔT is not available, the flow proceeds to step S35. The processing from step S35 is the same as that in FIG. 8, and therefore, the description thereof will be omitted.

As above, the power consumption verification support apparatus 1c displays the approximately calculated value of the power consumption on the display module of the display apparatus 103 up to the evaluation point by the result display control module 26, and allows the user to select the predetermined time ΔT for which the user desires to perform dump processing, and therefore, dump processing for an arbitrary predetermined time ΔT can be executed.

### Fifth Embodiment

Next, a fifth embodiment will be described.

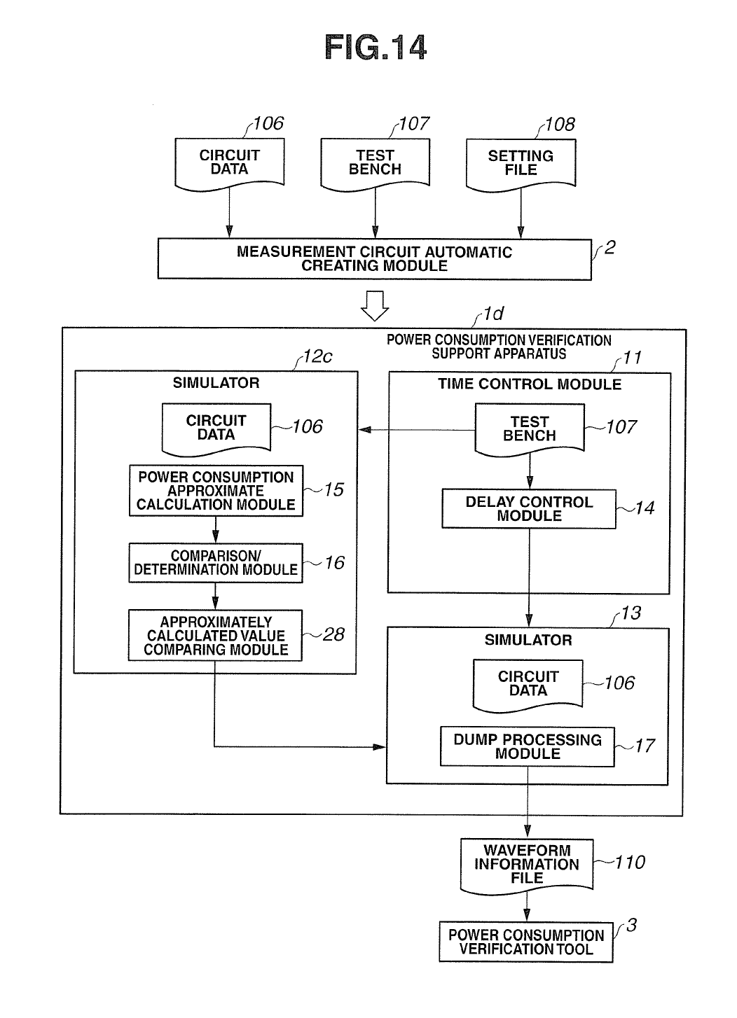

FIG. 14 is a diagram showing a configuration of a power consumption verification support apparatus according to the fifth embodiment. In FIG. 14, the same components as those in FIG. 2 are assigned with the same reference numerals, and the description thereof will be omitted.

A power consumption verification support apparatus 1d is configured by using a simulator 12c instead of the simulator 12 of FIG. 2. The simulator 12c is configured by having an approximately calculated value comparison module 28 in addition to the power consumption approximate calculation module 15 and the comparison/determination module 16 of FIG. 2.

When the approximately calculated value of power consumption under processing that is approximately calculated in the power consumption approximate calculation module 15 is the threshold value TH or larger, the comparison/determination module 16 temporarily stores the information of the predetermined time ΔT and the information of the approximately calculated value in the storage apparatus 102, as the candidate for performing dump processing.

When the data of the approximately calculated value of the power consumption that is stored is present, the approximately calculated value comparison module 28 compares the approximately calculated value of power consumption that is stored and the approximately calculated value of the power consumption of the predetermined time ΔT under processing. Subsequently, when the approximately calculated value of the power consumption of the predetermined time ΔT under processing is larger than the approximately calculated value of the power consumption that is stored, the approximately calculated value comparison module 28 temporarily stores the approximately calculated value of the power consumption of the predetermined time ΔT under processing in the storage apparatus 102 as the candidate for which dump processing is performed. On the other hand, when the approximately calculated value of the power consumption of the predetermined time ΔT under processing is less than the approximately calculated value of the power consumption that is stored, the approximately calculated value comparison module 28 instructs the dump processing module 17 to perform dump processing for the predetermined time ΔT that is stored in the dump processing module 17.

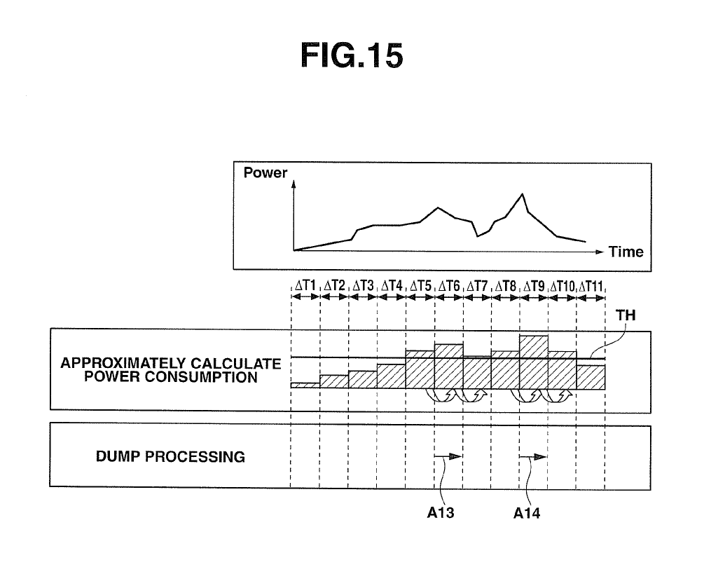

FIG. 15 is a diagram for explaining an operation of the power consumption verification support apparatus according to the fifth embodiment.

Since the approximately calculated value of the power consumption is the threshold value TH or larger in the predetermined time ΔT5, the information of the predetermined time ΔT5 and the information of the approximately calculated value are stored in the storage apparatus 102 as the candidate for dump processing by the comparison/determination module 16. Next, since the approximately calculated value of the power consumption is the threshold value TH or larger in the predetermined time ΔT6, the approximately calculated value of the power consumption in the predetermined time ΔT6 is compared with the approximately calculated value of the power consumption of the predetermined time ΔT5 that is stored by the approximately calculated value comparison module 28. Since the approximately calculated value of the power consumption of the predetermined time ΔT6 is larger than the approximately calculated value of the power consumption of the predetermined time ΔT5, the information of the approximately calculated value of the power consumption of the predetermined time ΔT6 is stored in the storage apparatus 102 as the candidate for dump processing.

Next, by the approximately calculated value comparison module 28, the approximately calculated value of the power consumption of a predetermined time ΔT7 is compared with the approximately calculated value of the power consumption of the predetermined time ΔT6 that is stored. Since the approximately calculated value of the power consumption of the predetermined time ΔT7 is less than the approximately calculated value of the power consumption of the predetermined time ΔT6, the dump processing module 17 is instructed to perform dump processing for the predetermined time ΔT6. The same processing is repeated for a predetermined time ΔT8 and the following times. Thereby, the dump processing for the predetermined times ΔT6 and ΔT9 shown by the arrows A13 and A14 is executed.

Next, a flow of the simulation for approximate calculation of power consumption that is executed in the simulator 12c will be described.

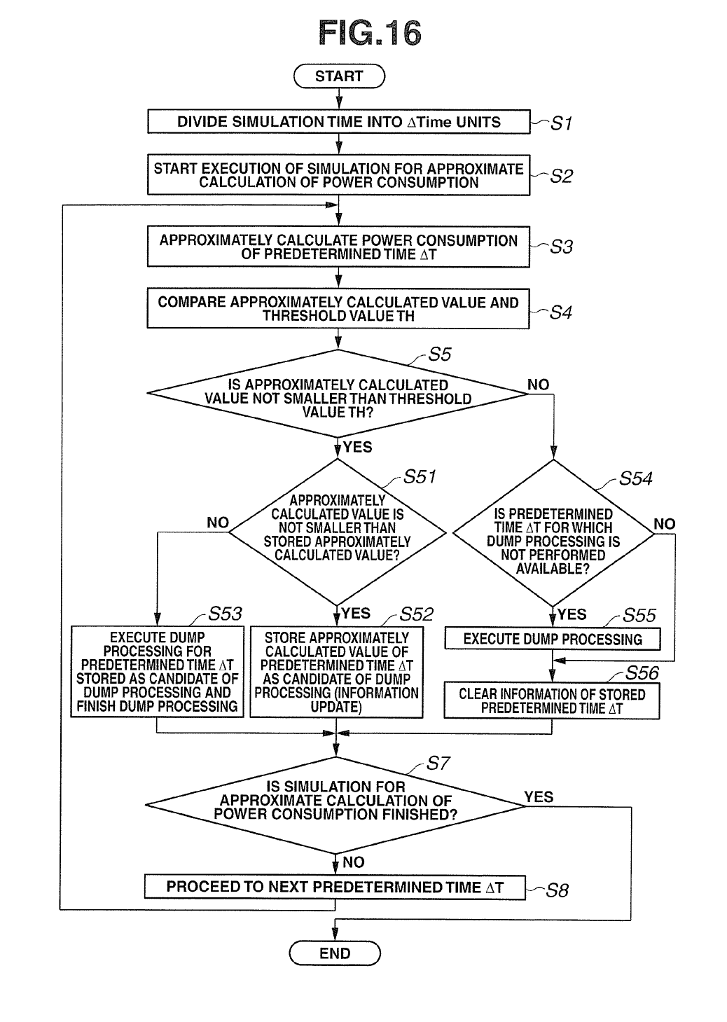

FIG. 16 is a flowchart showing an example of the flow of the simulation for approximate calculation of power consumption that is executed in the simulator 12c. In FIG. 16, the same processes as in FIG. 4 are assigned with the same reference numerals and characters, and the description thereof will be omitted.

When the approximately calculated value is determined as the threshold value TH or larger in step S5, it is determined whether or not the approximately calculated value of the predetermined time ΔT is the approximately calculated value that is stored or larger (step S51). If the approximately calculated value of the predetermined time ΔT is determined as the approximately calculated value that is stored or larger, the determination result is YES, the approximately calculated value of the predetermined time ΔT is stored as the candidate for dump processing (step S52), and the flow proceeds to step S7. On the other hand, if the approximately calculated value of the predetermined time ΔT is determined as less than the approximately calculated value that is stored, the determination result is NO, dump processing for the predetermined time ΔT that is stored as the candidate for dump processing is executed, and the dump processing is finished (step S53). Subsequently, the flow proceeds to step S7.

Further, if the approximately calculated value is determined as less than the threshold value TH in step S5, it is determined whether or not the predetermined time ΔT for which dump processing is not performed is available (step S54). If it is determined that the predetermined time ΔT for which dump processing is not performed is available, the determination result is YES, and dump processing is executed (step S55). On the other hand, if it is determined that the predetermined time ΔT for which dump processing is not performed is not available (step S54: NO), or if dump processing is executed in step S55, the information of the predetermined time ΔT that is stored is cleared (step S56), and the flow proceeds to step S7. Like this, when it is determined as YES or NO in step S54, if the flow goes to step S7, the information of the predetermined time ΔT that is stored is cleared. The information of the predetermined time ΔT that is stored does not have to be cleared. The processes of step S7 and the following steps are the same as those in FIG. 4, and therefore, the description thereof will be omitted.

As above, the power consumption verification support apparatus 1d determines whether or not to perform dump processing while comparing the approximately calculated values of power consumption of the preceding and the subsequent predetermined times ΔT, and therefore, can reduce the number of times of dump processes, as compared with the case of performing dump processing when the approximately calculated value is the threshold value TH or larger as the power consumption verification support apparatus 1 of the first embodiment.

### Sixth Embodiment

Next, a sixth embodiment will be described.

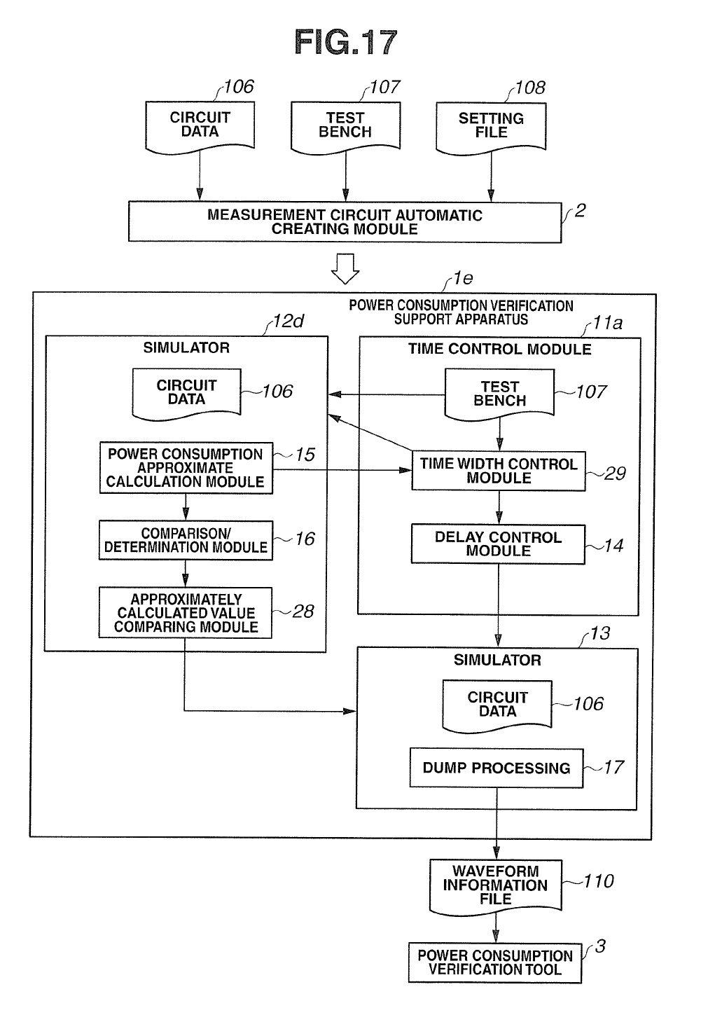

FIG. 17 is a diagram showing a configuration of a power consumption verification support apparatus according to the sixth embodiment. In FIG. 17, the same components as those in FIG. 14 are assigned with the same reference numerals and character, and the description thereof will be omitted.

A power consumption verification support apparatus 1e is configured by using a time control module 11a instead of the time control module 11 of FIG. 14. The time control module 11a is configured by having a time width control module 29 in addition to the delay control module 14 of FIG. 14.

The approximately calculated value of the power consumption is supplied to the time width control module 29 from the power consumption approximate calculation module 15. The time width control module 29 compares the approximately calculated value of the power consumption that is supplied and the threshold value TH, and performs control of changing the time width of the predetermined time ΔT of the simulation of the simulator 12c from the comparison result. More specifically, when the approximately calculated value of the power consumption is much less than the threshold value TH, the time width control module 29 increases the time width, and when the approximately calculated value of the power consumption is close to or exceeds the threshold value TH, the time width control module 29 decreases the time width. The other components are the same as those of the fifth embodiment, and therefore, the description thereof will be omitted.

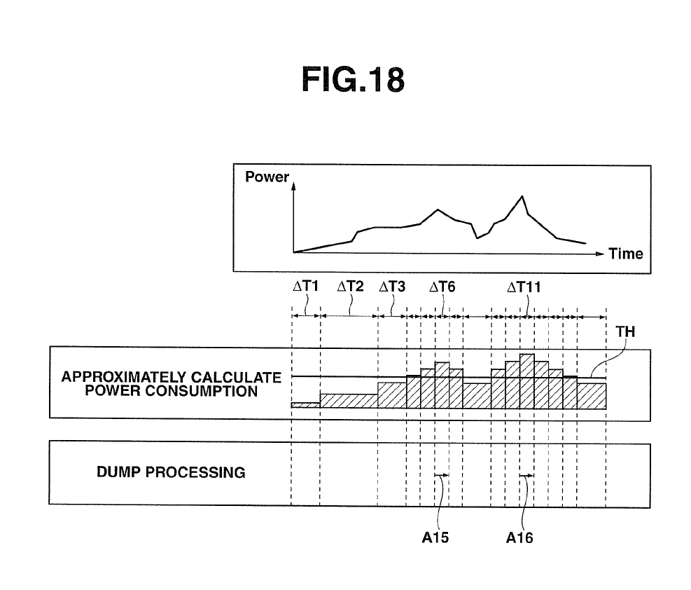

FIG. 18 is a diagram for explaining an operation of the power consumption verification support apparatus according to the sixth embodiment.

When the time width control module 29 determines that the approximately calculated value of the power consumption of the predetermined time ΔT1 is much less than the threshold value TH, the time width control module 29 increases the time width of the next predetermined time ΔT2. Next, when the time width control module 29 determines that the approximately calculated value of the power consumption of the predetermined time ΔT2 is close to the threshold value TH, the time width control module 29 decreases the time width of the next predetermined time ΔT3. The other operations are the same as those of the power consumption verification support apparatus 1d of FIG. 14, and dump processing for the predetermined times ΔT6 and ΔT11 shown by the arrows A15 and A16 is executed.

Next, a flow of the simulation for approximate calculation of power consumption that is executed in the simulator 12d will be described.

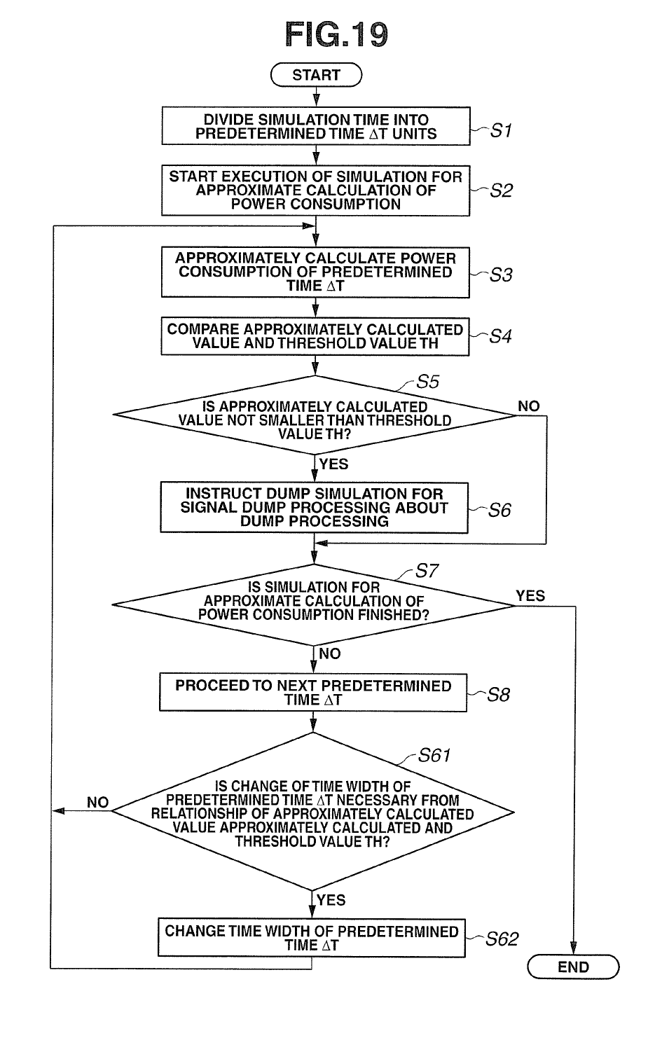

FIG. 19 is a flowchart showing an example of the flow of the simulation for approximate calculation of power consumption that is executed in the simulator 12d. In FIG. 19, the same processes as those in FIG. 4 are assigned with the same reference numerals and characters, and the description thereof will be omitted.

When it is determined that the simulation for approximate calculation of power consumption is not finished in step S7, and the flow goes to the next predetermined time ΔT in step S8, it is determined whether or not change of the time width of the predetermined time ΔT is necessary from the relationship of the approximately calculated value that is approximately calculated and the threshold value TH (step S61). If it is determined that change of the time width is not necessary, the determination result is NO, the flow returns to step S3, and the same processes are repeated. On the other hand, if change of the time width is determined to be necessary, the determination result is YES, and the time width of the predetermined time ΔT is changed (step S61). The flow returns to step S3, and the same processes are repeated. The other processes are the same as those in FIG. 4, and therefore, the description thereof will be omitted.

As above, the power consumption verification support apparatus 1e compares the approximately calculated value of the power consumption and the threshold value TH and controls the time width of the predetermined time ΔT in the time width control module 29, and therefore, can acquire the approximately calculated value of the power consumption of the time zone in which the approximately calculated value of the power consumption exceeds the threshold value TH, in detail.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power consumption verification support apparatus, comprising:
a power consumption approximate calculation module configured to approximately calculate power consumption for each of predetermined time of a first simulation that observes a designation signal,
a comparison/determination module configured to compare an approximately calculated value of the power consumption which is approximately calculated in the power consumption approximate calculation module with a threshold value, and determine whether or not to perform dump processing for each of the predetermined time from a comparison result;
a delay control module configured to cause a second simulation that observes all signals to be executed by delaying the second simulation by the predetermined time with respect to the first simulation; and
a dump processing module configured to store waveform data of all the signals during the predetermined time for which the dump processing is determined to be performed, based on a determination result of the comparison/determination module.

2. The power consumption verification support apparatus of claim 1,
wherein the comparison/determination module determines to perform the dump processing when the approximately calculated value of the power consumption which is approximately calculated in the power consumption approximate calculation module is the threshold value or larger, and determines not to perform the dump processing when the approximately calculated value of the power consumption which is approximately calculated in the power consumption approximate calculation module is less than the threshold value.

3. The power consumption verification support apparatus of claim 1, further comprising:
a database creating module configured to create a database for executing a simulation again from a starting time of the predetermined time of the first simulation; and
a database reading module configured to read the database and cause the simulation to be executed again from the starting time of the predetermined time, when the dump processing is determined to be performed by the comparison/determination module.

4. The power consumption verification support apparatus of claim 3,
wherein when the dump processing is determined to be performed by the comparison/determination module, the dump processing module executes a simulation again from the starting time of the predetermined time, based on the database read by the database reading module.

5. The power consumption verification support apparatus of claim 1, further comprising:
a display control module configured to display information of the approximately calculated value of the power consumption on a display module at a set evaluation point; and
an input module configured to allow the predetermined time for which the dump processing is performed to be selected according to the approximately calculated value of the power consumption that is displayed on the display module,
wherein the dump processing module performs dump processing during the predetermined time selected in the input module.

6. The power consumption verification support apparatus of claim 5,
wherein the evaluation point corresponds to an integral multiple of the predetermined time.

7. The power consumption verification support apparatus of claim 1, further comprising:
an approximately calculated value comparison module configured to compare an approximately calculated value of power consumption during the predetermined time which is approximately calculated in the power consumption approximate calculation module, and an approximately calculated value of power consumption which is approximately calculated in a predetermined time before the predetermined time, and determine whether or not dump processing during the predetermined time is necessary based on a comparison result.

8. The power consumption verification support apparatus of claim 7,
wherein the approximately calculated value comparison module determines that dump processing during the predetermined time is unnecessary when the approximately calculated value of power consumption during the predetermined time is equal to or larger than the approximately calculated value of power consumption which is approximately calculated in a predetermined time before the predetermined time, and determines that dump processing during the predetermined time is necessary when the approximately calculated value of the power consumption during the predetermined time is less than the approximately calculated value of power consumption which is approximately calculated in a predetermined time before the predetermined time.

9. The power consumption verification support apparatus of claim 1, further comprising:
a time width control module configured to perform control of changing a time width of the predetermined time during the first simulation, based on a relationship of the approximately calculated value of the power consumption and the threshold value.

10. The power consumption verification support apparatus of claim 9,
wherein when the approximately calculated value of the power consumption is much less than the threshold value, the time width control module increases the time width of the predetermined time, and when the approximately calculated value of the power consumption is close to or exceeds the threshold value, the time width control module decreases the time width of the predetermined time.

11. A power consumption verification support method, comprising:
power consumption approximate calculating to approximately calculate power consumption for each of predetermined time of a first simulation that observes a designation signal;
comparing and determining to compare an approximately calculated value of the power consumption which is approximately calculated in the power consumption approximate calculating with a threshold value, and determine whether or not to perform dump processing for each of the predetermined time from a comparison result;
delay controlling to cause a second simulation that observes all signals to be executed by delaying the second simulation by the predetermined time with respect to the first simulation; and
dump processing to store waveform data of all the signals during the predetermined time for which the dump processing is determined to be performed, based on a determination result of the comparing and determining.

12. The power consumption verification support method of claim 11,
wherein in the comparing and determining, it is determined to perform the dump processing when the approximately calculated value of the power consumption which is approximately calculated in the power consumption approximate calculating is the threshold value or larger, and it is determined not to perform the dump processing when the approximately calculated value of the power consumption which is approximately calculated in the power consumption approximate calculating is less than the threshold value.

13. The power consumption verification support method of claim 11, further comprising:
database creating to create a database for executing a simulation again from a starting time of the predetermined time of the first simulation; and
database reading to read the database and cause the simulation to be executed again from the starting time of the predetermined time, when it is determined to perform the dump processing by the comparing and determining.

14. The power consumption verification support method of claim 13,
wherein in the dump processing, when it is determined to perform the dump processing by the comparing and determining, the simulation is executed again from the starting time of the predetermined time, based on the database read in the database reading.

15. The power consumption verification support method of claim 11, further comprising:
display controlling to display information of the approximately calculated value of the power consumption on a display module at a set evaluation point; and
inputting to allow the predetermined time for which the dump processing is performed to be selected according to the approximately calculated value of the power consumption that is displayed on the display module,
wherein in the dump processing, dump processing during the predetermined time selected in the inputting is performed.

16. The power consumption verification support method of claim 15,
wherein the evaluation point corresponds to an integral multiple of the predetermined time.

17. The power consumption verification support method of claim 11, further comprising:
approximately calculated value comparing to compare an approximately calculated value of power consumption during the predetermined time which is approximately calculated in the power consumption approximate calculating, and an approximately calculated value of power consumption which is approximately calculated in a predetermined time before the predetermined time, and determine whether or not dump processing during the predetermined time is necessary based on a comparison result.

18. The power consumption verification support method of claim 17,
wherein in the approximately calculated value comparing, it is determined that dump processing during the predetermined time is unnecessary when the approximately calculated value of power consumption during the predetermined time is equal to or larger than the approximately calculated value of power consumption which is approximately calculated in a predetermined time before the predetermined time, and it is determined that dump processing during the predetermined time is necessary when the approximately calculated value of power consumption during the predetermined time is less than the approximately calculated value of power consumption which is approximately calculated in a predetermined time before the predetermined time.

19. The power consumption verification support method of claim 11, further comprising:
time width controlling to perform control of changing a time width of the predetermined time during the first simulation, based on a relationship of the approximately calculated value of the power consumption and the threshold value.

20. The power consumption verification support method of claim 19,
wherein in the time width controlling, when the approximately calculated value of the power consumption is much less than the threshold value, the time width of the predetermined time is increased, and when the approximately calculated value of the power consumption is close to or exceeds the threshold value, the time width of the predetermined time is decreased.
